(19) United States
(12) Patent Application Publication
(10) Pub. No.: US 2013/0085663 A1
(43) Pub. Date: Apr. 4, 2013

(54) NAVIGATION METHOD OF TRACKING A DYNAMIC TARGET AND PORTABLE ELECTRONIC DEVICE THEREOF

(71) Applicant: Sheng-Ta Hsieh, New Taipei City (TW)

(72) Inventor: Sheng-Ta Hsieh, New Taipei City (TW)

(21) Appl. No.: 13/398,800

(22) Filed: Feb. 16, 2012

(30) Foreign Application Priority Data
Oct. 3, 2011 (TW) 100135726

(51) Int. Cl. G01C 21/00

(52) U.S. Cl. 701/409; 701/468

(57) ABSTRACT

A navigation method of tracking a dynamic target for navigation is disclosed in the present invention. The dynamic target is a portable electronic device having network function and GPS function. The navigation method includes connecting to internet, executing register of a global positioning system and setting a network group for communicating with the dynamic target, setting coordinate information outputted from the dynamic target to be a navigating target, and executing navigation by the navigating target and the global positioning system.

### BACKGROUND OF THE INVENTION

1. Field of the Invention

The present invention relates to a navigation method, and more particularly, to a navigation method of tracking a dynamic target and a portable electronic device thereof.

2. Description of the Prior Art

A conventional navigator can set the known location to be a navigating target of the navigation, and plan the suitable path by the global positioning system for reference. Generally, a static target is set as a destination of the navigation by the conventional navigator. A user can use the conventional navigator to provide the navigation when going to an unfamiliar location. However, the conventional navigator is complicated and inconvenient as being used in a group travel. In the group travel, members include a guider who knows the path well and companions unacquainted with the path. The companions move with the guider in the group travel, and the conventional navigator can not help the companions to follow the guider. Therefore, design of a method of tracking a dynamic target to execute the navigation conveniently and effectively by utilizing hardware of the conventional navigator is an important issue in the related industry.

### SUMMARY OF THE INVENTION

The present invention provides a navigation method of tracking a dynamic target and a portable electronic device thereof for solving above drawbacks.

According to the claimed invention, the navigation method of tracking a dynamic target for navigation is disclosed. The dynamic target is a portable electronic device having internet and global positioning system functions. The navigation method includes connecting to internet, executing register of a global positioning system and setting a network group for communicating with the dynamic target, setting coordinate information outputted from the dynamic target to be a navigating target, and executing navigation by the global positioning system and the coordinate information outputted from the dynamic target.

According to the claimed invention, connecting to the internet includes utilizing wireless network to connect to the internet, and acquiring an IP address.

According to the claimed invention, executing the register of the global positioning system and setting the network group for communicating with the dynamic target includes establishing connection with the dynamic target, receiving an IP address of the dynamic target for establishing the network group, starting the global positioning system, outputting position information, and determining whether the dynamic target receives the position information and executing a corresponding operation according to determining result.

According to the claimed invention, determining whether the dynamic target receives the position information and executing the corresponding operation according to the determining result includes establishing the connection with the dynamic target when the dynamic target does not receive the position information.

According to the claimed invention, determining whether the dynamic target receives the position information and executing the corresponding operation according to the determining result includes completing the register of the global positioning system and the network group setting when the dynamic target receives the position information.

According to the claimed invention, setting the coordinate information outputted from the dynamic target to be the navigating target includes utilizing the internet to receive the coordinate information outputted from the dynamic target, setting the coordinate information to be the navigating target of the navigation, setting an update frequency for repeatedly receiving the coordinate information, and comparing the received coordinate information and the updated coordinate information for determining whether to reset the navigating target according to comparison.

According to the claimed invention, comparing the received coordinate information and the updated coordinate information for determining whether to reset the navigating target according to the comparison includes setting the updated coordinate information to be the navigating target when the updated coordinate information is different from the received coordinate information.

According to the claimed invention, comparing the received coordinate information and the updated coordinate information for determining whether to reset the navigating target according to the comparison includes finishing setting of the navigating target when the updated coordinate information is the same as the received coordinate information.

According to the claimed invention, the navigation method further includes comparing relation between the outputting position information and the coordinate information of the dynamic target for determining whether to stop the navigation.

According to the claimed invention, a navigation method of providing coordinate information for navigation by a tracking device is disclosed. The tracking device is a portable electronic device having internet and global positioning system functions. The navigation method includes connecting to internet, executing register of a global positioning system and setting a network group for communicating with the dynamic target, and outputting coordinate information generated by the global positioning system.

According to the claimed invention, executing the register of the global positioning system and setting the network group for communicating with the dynamic target includes establishing connection with the tracking device, receiving an IP address of the tracking device for establishing the network group, and starting the global positioning system for receiving the coordinate information.

According to the claimed invention, the navigation method further includes determining whether the tracking device receives the coordinate information, and establishing connection with the tracking device when the tracking device does not receive the coordinate information.

According to the claimed invention, the navigation method further includes outputting the coordinate information generated by the global positioning system according to a predetermined update frequency when the tracking device receives the coordinate information.

According to the claimed invention, a portable electronic device includes a memory unit for storing map information, a positioning unit for receiving position information generated by a global positioning system, a communicating unit for connecting to internet, a screen, and a controlling unit electrically connected to the memory unit, the positioning unit, the communicating unit and the screen. The controlling unit is for utilizing the internet to transmit an IP address generated by the communicating unit so as to establish a network group with the other portable electronic device, for utilizing the internet to transmit the position information so as to connect with the other portable electronic device to execute navigation, and further for displaying a navigating result and the map information on the screen.

The navigation method of tracking the dynamic target and the related portable electronic device of the present invention can be set for tracking the static target, for tracking the dynamic target, and for providing the coordinate information to be tracked. The portable electronic device of the present invention can be applied in a group travel, to supply the convenient, safe and useful navigation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a portable electronic device according to an embodiment of the present invention.

FIG. 2 is a flow chart of operation of the portable electronic device according to a first embodiment of the present invention.

FIG. 3 is a flow chart of execution of the register of the global positioning system and the network group setting of the portable electronic device according to the first embodiment of the present invention.

FIG. 4 is a flow chart of the navigating target setting of the portable electronic device according to the first embodiment of the present invention.

FIG. 5 is a flow chart of the portable electronic device according to a second embodiment of the present invention.

### DETAILED DESCRIPTION

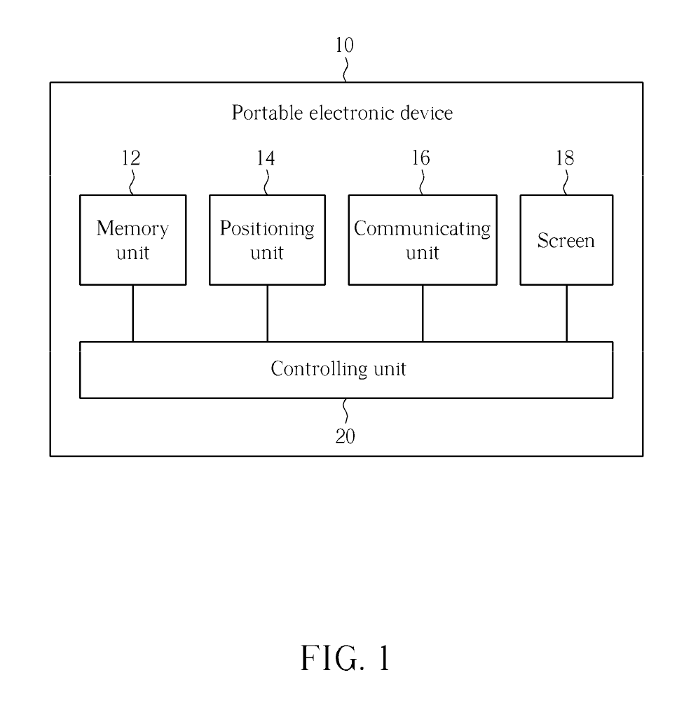

Please refer to FIG. 1. FIG. 1 is a functional block diagram of a portable electronic device 10 according to an embodiment of the present invention. The portable electronic device 10 can be a navigator having internet and global positioning system functions. The portable electronic device 10 of the present invention can utilize the internet to receive position information of the other portable electronic device, so as to set the position information of the other portable electronic device to be a destination of the navigation. As a user who holds the other portable electronic device moves, the portable electronic device 10 can continuously update the newest position information of the other portable electronic device for amending a navigation route.

That is to say, the portable electronic device 10 of the present invention can set a dynamic target to be the destination. When members separately move, each member can utilize the portable electronic device 10 to guide an accurate way to meet companions. For example, the portable electronic device of a captain can continuously output its newest position information, and the other members can set the position information of the captain to be a navigating target, so as to catch up with the captain easily and rapidly. Therefore, the portable electronic device 10 of the present invention can be applied to mountain climbing or motorcade parade.

As shown in FIG. 1, the portable electronic device 10 includes a memory unit 12, a positioning unit 14, a communicating unit 16, a screen 18 and a controlling unit 20. The memory unit 12 stores map information. The positioning unit 14 can include a positioning chip and a positioning antenna for receiving positioning coordinate information outputted by GPS satellites. The communicating unit 16 can be a normal wireless network card for connecting to the internet and transmitting information. The controlling unit 20 can be electrically connected to the memory unit 12, the positioning unit 14, the communicating unit 16 and the screen 18.

The portable electronic device 10 can be connected to the internet via the communicating unit 16 to acquire an IP address, and the controlling unit 20 can utilize the internet to transmit the IP address to the other portable electronic device, so as to ensure that a network group can be established successfully between the portable electronic devices. After the network group has established, the portable electronic device 10 can further utilize the internet to transmit the position information received by the positioning unit 14 to the other portable electronic device for executing the navigation. Then, a navigating result can be displayed on the screen 18 with the map information stored in the memory unit 12 for reference.

Generally, the portable electronic device 10 can be a tracking device or a target device according to user's demand. The captain can set its portable electronic device 10 to be the target device for outputting the position information via the internet, so that the other portable electronic devices, which are hold by the companions, can receive the position information of the captain for executing the navigation. The other members can set their portable electronic device 10 to be the tracking devices. The tracking device receives the position information outputted from the target device via the internet, and sets the position information to be the navigating target. Thus, the portable electronic device 10 of the present invention can track the dynamic target for executing the navigation. In addition, the portable electronic device 10 which is the target device can further selectively set a static target to be the navigating target. The setting procedure is the same as the conventional navigator, and detailed description is omitted herein for simplicity.

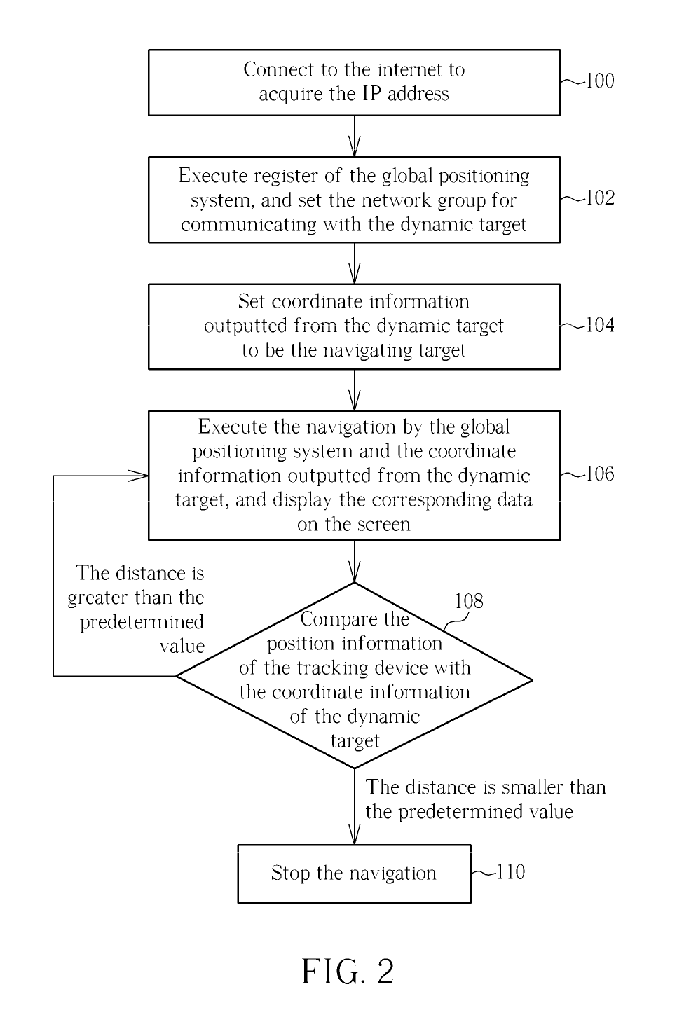

Please refer to FIG. 2. FIG. 2 is a flow chart of operation of the portable electronic device 10 according to a first embodiment of the present invention. The portable electronic device 10 of the first embodiment can be set as the tracking device for tracking the dynamic target (the other portable electronic device) and executing the navigation. The navigation method includes following:

Step 100: Utilize the communicating unit 16 to connect to the internet, and acquire the IP address.

Step 102: The controlling unit 20 executes register of the global positioning system, and sets the network group for communicating with the dynamic target.

Step 104: Set coordinate information outputted from the dynamic target to be the navigating target.

Step 106: The controlling unit 20 executes the navigation by the global positioning system and the coordinate information outputted from the dynamic target, and displays the corresponding data on the screen 18.

Step 108: Compare the position information of the tracking device (the portable electronic device 10 that the user holds) with the coordinate information of the dynamic target (the other portable electronic device that the companion holds). Execute step 106 when a distance between the position information of the tracking device and the coordinate information of the dynamic target is substantially greater than a predetermined value; Execute step 110 when the distance between the position information of the tracking device and the coordinate information of the dynamic target is substantially smaller than the predetermined value.

Step 110: Stop the navigation.

The detail description is introduced as following. The flow chart of the first embodiment of the present invention is the setting operation of the portable electronic device 10 for searching the companions. First, network connection of the portable electronic device 10 can be started for driving the communicating unit 16 to connect to the internet via the wireless network, such as GPRS, 3G, WiFi, WiMax and so on. The portable electronic device 10 can acquire the IP address simultaneously when login the internet. After, the controlling unit 20 can automatically execute the register of the global positioning system and set the network group for communicating with the dynamic target. Above procedure is introduced as following, and detail description is omitted herein for simplicity.

The controlling unit 20 can drive the communicating unit 16 to receive the coordinate information outputted from the dynamic target (via the internet) after setting the network group. The coordinate information can be longitude and latitude of the dynamic target detected by the global positioning system. Therefore, the portable electronic device 10 of the first embodiment can set the coordinate information outputted from the dynamic target to be the navigating target, which means the destination of the navigation. Then the portable electronic device 10 can start the global positioning system to execute the navigation, and display the navigating information and the corresponding map information on the screen 18 (or further utilize a speaker to display audio navigating information) for reference.

In addition, the portable electronic device 10 of the present invention can determine whether to stop the navigation according to relation between its position information and the coordinate information of the dynamic target. For example, as the distance between the position information of the portable electronic device 10 and the coordinate information of the dynamic target is substantially greater than the predetermined value, such as more than hundreds meters, the user who holds the portable electronic device 10 is far away the companion who holds the other portable electronic device (the dynamic target), which means the distance between the user and the companion is greater than visible range, the controlling unit 20 of the portable electronic device 10 executes step 106 for keeping the navigation. As the distance between the position information of the portable electronic device 10 and the coordinate information of the dynamic target is substantially smaller than the predetermined value, which means that the user who holds the portable electronic device 10 arrives the destination, or is under the visible range of the companion who holds the other portable electronic device (the dynamic target), the controlling unit 20 can output a prompting message, then the user can determine whether to stop the navigation according to the prompting message.

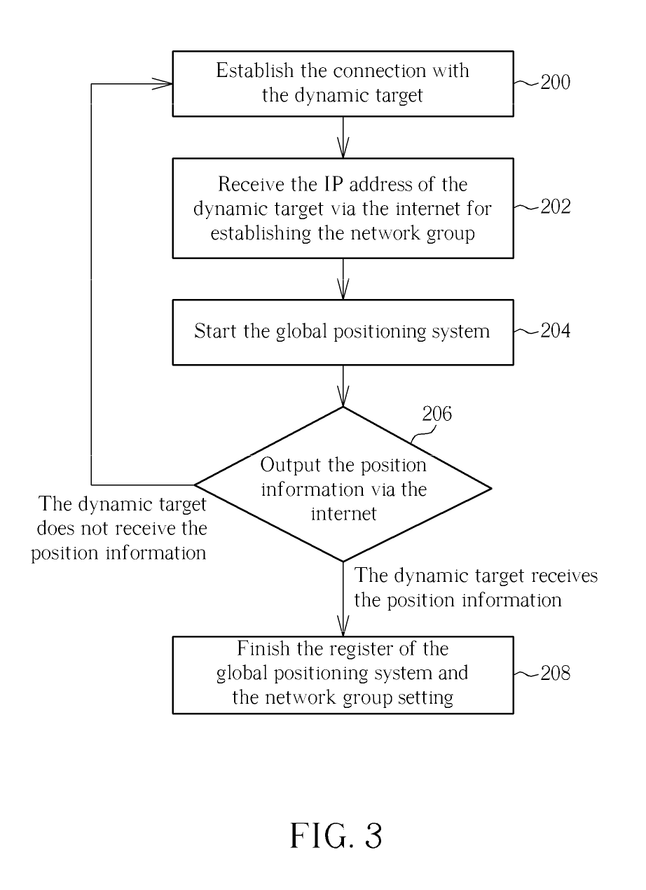

Please refer to FIG. 3. FIG. 3 is a flow chart of execution of the register of the global positioning system and the network group setting of the portable electronic device 10 according to the first embodiment of the present invention. The navigation method includes following:

Step 200: Establish the connection with the dynamic target.

Step 202: Receive the IP address of the dynamic target via the internet for establishing the network group.

Step 204: Start the global positioning system.

Step 206: Output the position information via the internet. Execute step 208 when determines that the dynamic target receives the position information; Execute step 200 when determines that the dynamic target does not receive the position information.

Step 208: Finish the register of the global positioning system and the network group setting.

The detail description is introduced as following. The flow chart shown in FIG. 3 is an introduction of step 102 shown in FIG. 1. The portable electronic device 10 of the first embodiment can utilize the communicating unit 16 to establish the connection with the dynamic target via the internet, and simultaneously acquire the IP address of the dynamic target through the connection. Then, the portable electronic device 10 can set its IP address and the IP address of the dynamic target to into the same network group, so as to ensure that the portable electronic device 10 and the dynamic target can stably transmit the information to each other via the internet.

The controlling unit 20 can be further for starting the global positioning system, so as to login the GPS satellites to obtain the position information of the portable electronic device 10, such as the information including longitude and latitude. Besides, the portable electronic device 10 of the first embodiment can output the position information to the dynamic target by the network group (which means via the internet). As the controlling unit 20 does not receive verification packages replied from the dynamic target, the controlling unit 20 can execute step 200 to reestablish the connection for detecting correction of the connection. As the controlling unit 20 receives the verification packages replied from the dynamic target, the controlling unit 20 completely finishes the register of the global positioning system and the network group setting, and step 102 shown in FIG. 1 is accurately executed.

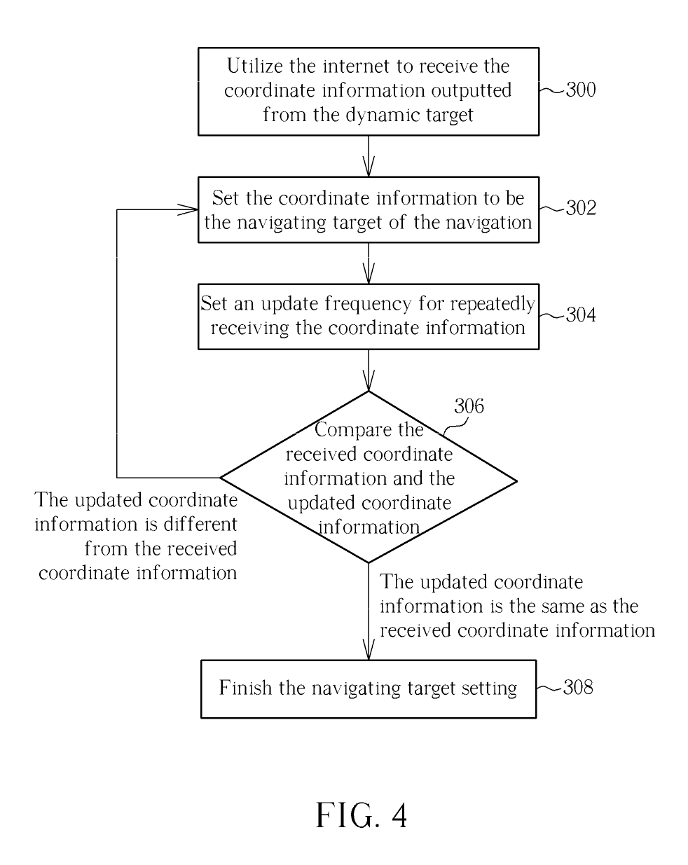

Please refer to FIG. 4. FIG. 4 is a flow chart of the navigating target setting of the portable electronic device 10 according to the first embodiment of the present invention. The navigation method includes following:

Step 300: Utilize the internet to receive the coordinate information outputted from the dynamic target.

Step 302: Set the coordinate information to be the navigating target of the navigation.

Step 304: Set an update frequency for repeatedly receiving the coordinate information.

Step 306: Compare the received coordinate information and the updated coordinate information. Execute step 302 when the updated coordinate information is different from the received coordinate information; Execute step 308 when the updated coordinate information is the same as the received coordinate information.

Step 308: Finish the navigating target setting.

The detail description is introduced as following. Step 104 shown in FIG. 1 is illustrated in the flow path shown in FIG. 4. The portable electronic device 10 of the first embodiment can drive the communicating unit 16 to receive the coordinate information outputted from the dynamic target via the internet according to the above-mentioned illustration. The user can set the coordinate information to be the navigating target of the navigation of the portable electronic device 10, which means the destination, after catching the dynamic target. Because the dynamic target keeps moving during the navigation, the user can manually set (or set parameters according original setting) the update frequency for repeatedly receiving the coordinate information outputted from the dynamic target when the dynamic target moves.

For example, the portable electronic device 10 can be set to repeatedly receive the coordinate information of the dynamic target per five seconds when the portable electronic device 10 is applied to the motorcade parade. The portable electronic device 10 can be set to repeatedly receive the coordinate information of the dynamic target per sixty seconds when the portable electronic device 10 is applied to the mountain climbing. The update frequency is not limited to the above-mentioned embodiment, and depends on actual demand, such as a moving speed of the portable electronic device. Therefore, the controlling unit 20 can automatically reset the updated coordinate information to be the navigating target when the updated coordinate information is different from the received coordinate information, and can further drive the screen 18 to keep displaying the analyzed map information and the former navigating information when the updated coordinate information is the same as the received coordinate information.

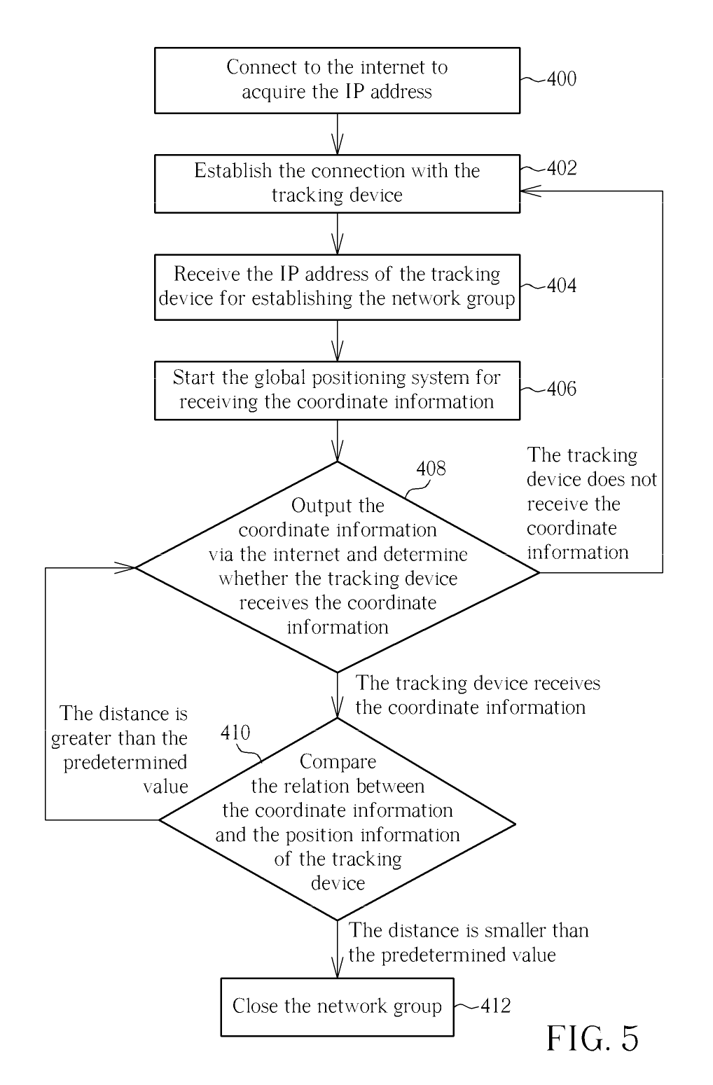

Comparing to the first embodiment, the portable electronic device of the present invention can be further used as the target device for providing the coordinate information, so that the tracking device of the first embodiment can catch the position information of the target device for executing the navigation. Please refer to FIG. 5. FIG. 5 is a flow chart of the portable electronic device 10′ according to a second embodiment of the present invention. The navigation method includes following:

Step 400: Utilize the wireless network to connect to the internet, and acquire the IP address.

Step 402: Establish the connection with the tracking device.

Step 404: Receive the IP address of the tracking device for establishing the network group.

Step 406: Start the global positioning system for receiving the coordinate information.

Step 408: Output the coordinate information generated by the global positioning system and determine whether the tracking device receives the coordinate information. Execute step 402 when the tracking device does not receive the coordinate information; Execute step 410 when the tracking device receives the coordinate information.

Step 410: Compare the relation between the owned coordinate information (from the portable electronic device 10′ that the user holds) and the position information of the tracking device (the portable electronic device that the companion holds). Execute step 408 when the distance between the coordinate information of the target device and the position information of the tracking device is substantially greater than the predetermined value; Execute step 412 when the distance between the coordinate information of the target device and the position information of the tracking device is substantially smaller than the predetermined value.

Step 412: Close the network group to stop outputting the coordinate information.

The detail description is introduced as following. The portable electronic device 10′ of the second embodiment has the same structures and functions as the portable electronic device 10 of the first embodiment, and detailed description is omitted herein for simplicity. First, the portable electronic device 10′ can utilize the wireless network to connect to the internet for acquiring the IP address, and simultaneously establish the connection with the tracking device. The portable electronic device 10′ can receive the IP address of the tracking device via the internet, so that the portable electronic device 10′ and the tracking device can be set into the same network group, to complete the communication setting with the tracking device. Then, the portable electronic device 10′ can start the global positioning system for receiving the coordinate information to finish the register of the global positioning system.

For providing the navigating target to the tracking device, the portable electronic device 10′ can output the coordinate information generated by the global positioning system to the tracking device via the internet. The portable electronic device 10′ can reestablish the connection with the tracking device for transmitting the coordinate information via the internet when determining that the tracking device does not receive the coordinate information. Position of the portable electronic device 10′ is varied because its movement follows the owner. As the tracking device receives the coordinate information successfully, the portable electronic device 10′ can output the updated coordinate information according to the predetermined update frequency to the tracking device, so that the tracking device can reset the navigating target immediately for executing the navigation of tracking the dynamic target.

In addition, the portable electronic device 10′ can further receive the position information of the tracking device via the internet, and compare the relation between the coordinate information and the position information. The portable electronic device 10′ can continuously output the updated coordinate information to be received and be analyzed by the tracking device when the distance between the portable electronic device 10′ and the tracking device is greater than the predetermined value. The portable electronic device 10′ can close the network group to stop outputting the coordinate information when the distance between the portable electronic device 10′ and the tracking device is smaller than the predetermined value, which means the tracking device is close to the visible range relative to the target device, for finishing the navigation. Besides, the portable electronic device 10′ can further set the destination information (the static target) to be the navigating target, and utilize the global positioning system and the destination information to execute the navigation. The setting about the static target is similar to an application of the conventional navigator, and detail description is omitted herein for simplicity.

In conclusion, the portable electronic device of the present invention can have functions to be the target device and to be the tracking device alternatively. As being the target device, the portable electronic device can acquire the coordinate information by the global positioning system, and transmit the coordinate information to the other electronic device (the tracking device) via the internet for analysis. As being the tracking device, the portable electronic device can receive the coordinate information of the dynamic target (the target device) via the internet, set the coordinate information of the dynamic target to be the navigating target of the navigation, and display the corresponding map information and the navigating result on the screen for reference. Because the coordinate information of the dynamic target is varied according its movement, the portable electronic device, which is the tracking device, can continuously receive the updated coordinate information outputted from the dynamic target according to the predetermined update frequency, and reset the updated coordinate information to be the navigating target, so as to immediately calculate and analyze the updated coordinate information for executing the navigation. Thus, the portable electronic device of the present invention can track the dynamic target for the navigation.

Comparing to the prior art, the navigation method of tracking the dynamic target for the navigation and the related portable electronic device of the present invention can be set for tracking the static target, for tracking the dynamic target, and for providing the coordinate information to be tracked. The portable electronic device of the present invention can be applied in a group travel, to supply the convenient, safe and useful navigation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A navigation method of tracking a dynamic target, the dynamic target being a portable electronic device having internet and global positioning system functions, the navigation method comprising:
connecting to internet;
executing register of a global positioning system and setting a network group for communicating with the dynamic target;
setting coordinate information outputted from the dynamic target to be a navigating target; and
executing navigation by the global positioning system and the coordinate information outputted from the dynamic target.

2. The navigation method of claim 1, wherein connecting to the internet comprises:
utilizing wireless network to connect to the internet; and
acquiring an IP address.

3. The navigation method of claim 1, wherein executing the register of the global positioning system and setting the network group for communicating with the dynamic target comprises:
establishing connection with the dynamic target;
receiving an IP address of the dynamic target for establishing the network group;
starting the global positioning system;
outputting position information; and
determining whether the dynamic target receives the position information and executing a corresponding operation according to determining result.

4. The navigation method of claim 3, wherein determining whether the dynamic target receives the position information and executing the corresponding operation according to the determining result comprises:
establishing the connection with the dynamic target when the dynamic target does not receive the position information.

5. The navigation method of claim 3, wherein determining whether the dynamic target receives the position information and executing the corresponding operation according to the determining result comprises:
completing the register of the global positioning system and the network group setting when the dynamic target receives the position information.

6. The navigation method of claim 1, wherein setting the coordinate information outputted from the dynamic target to be the navigating target comprises:
utilizing the internet to receive the coordinate information outputted from the dynamic target;
setting the coordinate information to be the navigating target of the navigation;
setting an update frequency for repeatedly receiving the coordinate information; and
comparing the received coordinate information and the updated coordinate information for determining whether to reset the navigating target according to comparison.

7. The navigation method of claim 6, wherein comparing the received coordinate information and the updated coordinate information for determining whether to reset the navigating target according to the comparison comprises:
setting the updated coordinate information to be the navigating target when the updated coordinate information is different from the received coordinate information.

8. The navigation method of claim 6, wherein comparing the received coordinate information and the updated coordinate information for determining whether to reset the navigating target according to the comparison comprises:
finishing setting of the navigating target when the updated coordinate information is the same as the received coordinate information.

9. The navigation method of claim 1, further comprising:
comparing relation between the outputting position information and the coordinate information of the dynamic target for determining whether to stop the navigation.

10. A navigation method of providing coordinate information for navigation by a tracking device, the tracking device being a portable electronic device having internet and global positioning system functions, the navigation method comprising:
connecting to internet;
executing register of a global positioning system and setting a network group for communicating with the dynamic target; and
outputting coordinate information generated by the global positioning system.

11. The navigation method of claim 10, wherein connecting to the internet comprises:
utilizing wireless network to connect to the internet; and
acquiring an IP address.

12. The navigation method of claim 10, wherein executing the register of the global positioning system and setting the network group for communicating with the dynamic target comprises:
establishing connection with the tracking device;
receiving an IP address of the tracking device for establishing the network group; and
starting the global positioning system for receiving the coordinate information.

13. The navigation method of claim 10, further comprising:
determining whether the tracking device receives the coordinate information; and
establishing connection with the tracking device when the tracking device does not receive the coordinate information.

14. The navigation method of claim 13, further comprising:
outputting the coordinate information generated by the global positioning system according to a predetermined update frequency when the tracking device receives the coordinate information.

15. The navigation method of claim 10, further comprising:
setting destination information to be a navigating target; and
executing the navigation by the global positioning system and the destination information.

16. The navigation method of claim 10, further comprising:
comparing relation between the outputting coordinate information and position information of the tracking device for determining whether to stop the network group.

17. A portable electronic device comprising:
a memory unit for storing map information;
a positioning unit for receiving position information generated by a global positioning system;
a communicating unit for connecting to internet;
a screen; and
a controlling unit electrically connected to the memory unit, the positioning unit, the communicating unit and the screen for utilizing the internet to transmit an IP address generated by the communicating unit so as to establish a network group with the other portable electronic device, for utilizing the internet to transmit the position information so as to connect with the other portable electronic device to execute navigation, and further for displaying a navigating result and the map information on the screen.

18. The portable electronic device of claim 17, wherein the controlling unit is further for driving the communicating unit to receive the position information of the other portable electronic device, and for setting the position information to be a navigating target so as to execute the navigation.

19. The portable electronic device of claim 17, wherein the controlling unit is further for driving the positioning unit to receive the position information generated by the global positioning system, so as to transmit the position information to the other portable electronic device via the communicating unit.

20. The portable electronic device of claim 19, wherein the controlling unit is further for setting a static target to be a navigating target so as to execute the navigation.
